(19) United States
(12) Patent Application Publication
(10) Pub. No.: US 2026/0142597 A1
(43) Pub. Date: May 21, 2026

(54) MOTOR STARTING METHOD AND MOTOR STARTING CIRCUIT

(71) Applicant: CRM ICBG (WUXI) CO., LTD., Wuxi (CN)

(72) Inventors: Chun HUA, Wuxi (CN); Xudong ZHAO, Wuxi (CN); Yafei LI, Wuxi (CN); Jing HUA, Wuxi (CN)

(73) Assignee: CRM ICBG (WUXI) CO., LTD., Wuxi (CN)

(21) Appl. No.: 19/114,800

(22) PCT Filed: Aug. 23, 2023
(86) PCT No.: PCT/CN2023/114363

§ 371 Date: Mar. 25, 2025

(30) Foreign Application Priority Data
Oct. 10, 2022 (CN) 2022112361734

(51) Int. Cl. H02P 21/34; H02P 5/74; H02P 21/00; H02P 21/18; H02P 21/22

(52) U.S. Cl. CPC H02P 21/34; H02P 5/74; H02P 21/0003; H02P 21/18; H02P 21/22

(57) ABSTRACT

A motor starting method and a motor starting circuit are disclosed. The motor starting method includes: (1) obtaining the rotor current position; (2) asynchronously driving the motor at the current rotor position and the rotation direction to gradually increase the open-loop angle to a target angle and gradually increase the quadrature-axis reference current, wherein the open-loop angular increment gradually increases with time to implement smooth starting; and (3) motor entering a closed-loop control mode. By introducing the open-loop angle, open-loop angular increment, and angular addition increment, implementing the hardware starting circuit becomes easier, only one adder can complete starting, consuming only a few hardware, thereby releasing the CPU resources. This smooth starting approach reduces the “gear shifting” feeling, speeds up the starting process, and lowers the risk of inversion. The technique can be applied to other motors with shared computational logic to reduce costs.

### FIELD OF TECHNOLOGY

The present disclosure relates to the field of motor control, and in particular, to a motor starting method and a motor starting circuit.

### BACKGROUND

Motors without a position sensor have low costs and high reliability, therefore are widely used in the field of motor control. Currently, in a technology of non-inductive control of motor running, field-oriented control (FOC) is an efficient control technology that can implement precise control for a brushless direct current motor and a permanent magnet synchronous motor. In a process of controlling motor running through FOC, a starting process of a motor generally includes an initial positioning stage, an accelerating asynchronous driving stage, a closed-loop control stage, and the like.

Initial positioning stage: rotor positioning is generally implemented by controlling a direct-axis reference current of the motor from zero to gradually increase to a positioning target current and maintaining the target current for a period of time within a preset positioning stabilization time.

Accelerated asynchronous driving stage: a direct-axis current of the to-be-controlled motor is controlled to gradually decrease, a quadrature-axis reference current gradually increases, and an open-loop angle of the to-be-controlled motor is controlled to gradually increase from a positioning angle to an asynchronous driving angle of a target starting open-loop angle to participate in FOC to asynchronously drive the motor.

Closed-loop control stage: After the asynchronous driving angle reaches the starting open-loop angle, the motor is controlled in a closed-loop control manner to run.

An acceleration curve of the accelerated asynchronous driving stage strongly depends on program settings by software engineers, and is mainly planned appropriately in real time through the understanding of motor characteristics by the software engineers. As a result, it takes a long time for the motor to reach a predetermined rotational speed, thus operating efficiency is low, and very difficult to meet the requirement of quick starting and running. Therefore, it is necessary to provide a new starting method to improve operating efficiency and increase a starting speed.

It should be noted that the above introduction to the technical background is only for providing a clear and complete explanation of the technical solution and facilitating understanding by technical personnel in this field. The above technical solutions should not be considered as known to technical personnel in this field simply because they are described in the background section of the present disclosure.

### SUMMARY

In view of the foregoing disadvantages in the existing technologies, the present disclosure provides a motor starting method and a motor starting circuit, to solve problems such as a slow motor starting speed and low motor efficiency without a position sensor in the existing technologies.

The present disclosure provides a motor starting method. The motor starting method at least includes:
(1) obtaining a current position of a rotor;
(2) asynchronously driving a motor at the current position of the rotor and the motor rotation direction, gradually increasing the open-loop angle to the target starting open-loop angle and gradually increasing the quadrature-axis reference current, where the open-loop angular increment gradually increases with time during the asynchronous driving to implement smooth starting; and
(3) making the motor enter a closed-loop control mode.

Optionally, the open-loop angle satisfies:

$${θ}_{n} = {θ}_{n - 1} + Δ {θ}_{n} , Δ {θ}_{n} = Δ {θ}_{n - 1} + {Δ}^{2} θ ,$$

where θₙ is the open-loop angle in a current period, θₙ₋₁ is the open-loop angle in a previous period, Δθₙ is the open-loop angle increment in the current period, Δθₙ₋₁ is the open-loop angular increment in the previous period, and Δ²θ is an angular addition increment.

Further optionally, the open-loop angle is adjusted in stages in Step (2), the angular addition increment of the open-loop angle in periods in a same stage is a constant value, and the angular addition increment of the open-loop angle in stages gradually increases with time.

Further optionally, the angular addition increment of the open-loop angle in an i^{th} stage in Step (2) satisfies:

$${Δ}^{2} {θ}_{i} = \frac{Δ {θ}_{in} - Δ {θ}_{i 0}}{{T}_{i} \times f - 1} ,$$

$$and$$

$${Δθ}_{i n} = \frac{N \times 360 ° \times p}{{T}_{i} \times f} ,$$

where Δ²θᵢ is the angular addition increment of the open-loop angle in the i^{th} stage, and i is a natural number greater than or equal to 1; Δθᵢₙ is a target angular increment in the last period in the i^{th} stage; Δθᵢ₀ is the open-loop angular increment in the first period in the i^{th} stage; Tᵢ is a time length (as an example, in the unit of seconds) of the i^{th} stage; f is a driving frequency (as an example, in the unit of hertz) of the motor; N is a target rotational speed (as an example, in the unit of revolution/second) in the i^{th} stage; p is the number of pole-pairs of the motor; and when i≥2, Δθᵢ₀=Δθ₍ᵢ₋₁₎ₙ, and Δθ₍ᵢ₋₁₎ₙ is the target angular increment in the last period in the (i−1)^{th} stage.

Further optionally, when the open-loop angular increment in one stage reaches the target angular increment in the corresponding stage, an angular velocity fulfillment interrupt signal is triggered, and the angular addition increment and a quadrature-axis reference current increment are cleared; and the angular addition increment and the quadrature-axis reference current increment in a next stage are recalculated, or the open-loop angular increment and the quadrature-axis reference current in the current period are maintained.

To achieve the foregoing objective and other related objectives, the present disclosure further provides a motor starting circuit. The motor starting circuit at least includes:
a sampling module, a first coordinate transformation module, a processor, a reference current auto-increment module, an angular acceleration control module, a proportional integral adjustment module, a second coordinate transformation module, a control signal generation module, a driving module, and a motor;
the sampling module samples a current of the motor;
the first coordinate transformation module is connected to an output end of the sampling module and an output end of the angular acceleration control module, and performs coordinate transformation on an output signal of the sampling module to obtain a direct-axis current and a quadrature-axis current;
the processor provides a direct-axis reference current, a quadrature-axis reference current, a quadrature-axis reference current increment, an initial angle, an initial open-loop angular increment, and an angular addition increment;
the reference current auto-increment module is connected to an output end of the processor, and obtains the quadrature-axis reference current in a current period based on the quadrature-axis reference current in a previous period and the quadrature-axis reference current increment;
the angular acceleration control module is connected to the output end of the processor, and adjusts an open-loop angle to a target starting open-loop angle based on the initial angle, the initial open-loop angular increment, and the angular addition increment, where an open-loop angular increment gradually increases with time;
the proportional integral adjustment module is connected to the first coordinate transformation module, the processor, and an output end of the reference current auto-increment module, and performs a proportional integral adjustment operation based on the direct-axis current, the direct-axis reference current, the quadrature-axis current, and the quadrature-axis reference current to obtain a direct-axis voltage and a quadrature-axis voltage;
the second coordinate transformation module is connected to the angular acceleration control module and an output end of the proportional integral adjustment module, and performs coordinate transformation on the direct-axis voltage and the quadrature-axis voltage to obtain three-phase voltages;
the control signal generation module generates a control signal for the motor based on an output signal of the second coordinate transformation module; and
the driving module is connected to an output end of the control signal generation module, and generates a driving signal for the motor based on the control signal and drives the motor to start.

Optionally, the angular acceleration control module includes an addition unit and a sine function and cosine function calculation unit;
the addition unit obtains the open-loop angle in the previous period, the open-loop angular increment in the previous period, and the angular addition increment in the current period to perform an addition operation to obtain the open-loop angular increment in the current period and the open-loop angle in the current period; and
the sine and cosine function calculation unit is connected to an output end of the addition unit, and performs sine and cosine function calculation on the open-loop angle outputted by the addition unit, where a sine and a cosine function outputted by the sine and cosine function calculation unit are configured for motor starting control.

Optionally, the angular acceleration control module further includes an upper limit control unit;
the upper limit control unit is connected to the addition unit, when the open-loop angular increment reaches a stage target angular increment, sends an angular velocity fulfillment interrupt signal, and when the open-loop angular increment is less than the target angular increment in the corresponding stage, controls the addition unit to perform an addition operation based on the open-loop angle in the previous period and the open-loop angular increment in the current period to obtain the open-loop angle in the current period.

Further optionally, the addition unit includes a register and an adder;
wherein the open-loop angle, the open-loop angular increment, and the angular addition increment are stored in the register; and
wherein the adder is connected to the register, and performs the addition operation on the open-loop angle in the previous period, the open-loop angular increment in the previous period, and the angular addition increment to obtain the open-loop angular increment in the current period and the open-loop angle in the current period.

Further optionally, the addition unit includes a multi-path multiplexer, an adder, and at least two registers;
open-loop angles, open-loop angular increments, and angular addition increments of motors are stored in the registers;
the multi-path multiplexer is connected to output ends of the registers, and selects one of the registers and outputs data in the selected register; and
the adder is connected to an output end of the multi-path multiplexer, and performs the addition operation on the open-loop angle in the previous period, the open-loop angular increment in the previous period, and the angular addition increment at the output end of the multi-path multiplexer to obtain the open-loop angular increment in the current period and the open-loop angle in the current period.

Optionally, the driving module includes a driving board, transforming a low-voltage domain signal into a high-voltage domain signal to drive the motor to run.

Optionally, the motor is a permanent magnet synchronous motor without a position sensor.

As discussed above, the motor starting method and the motor starting circuit in the present disclosure have the following beneficial effects:
1. For the motor starting method and the motor starting circuit in the present disclosure, the introduction of the open-loop angle, the open-loop angular increment, and the angular addition increment makes it easier to implement the starting circuit in hardware, and a starting process can be completed by using only one adder repeatedly, so that a few hardware resources are consumed, and CPU resources are not occupied.
2. For the motor starting method and the motor starting circuit in the present disclosure, smooth starting is implemented by adjusting the open-loop angular increment, and the “gear shifting” feeling in motor rotation is reduced during rate switching.
3. For the motor starting method and the motor starting circuit in the present disclosure, the introduction of the angular addition increment greatly accelerates starting progress and suppresses a probability of starting inversion within a particular range.
4. The motor starting method and the motor starting circuit in the present disclosure can be expanded to any group of motors, and the same group of computational logic is multiplexed for starting of the motors, so that costs are reduced.

### BRIEF DESCRIPTION OF THE DRAWINGS

FIG. 1 are sampled data curves of an open-loop angular increment and a quadrature-axis reference current in stages in an asynchronous driving process of a motor start;

FIG. 2 is the curve of sampled data points of an angle multiplied by the number of revolutions in an asynchronous driving process in stages;

FIG. 3 is waveforms of an electrical angle in an asynchronous driving process in motor starting stages;

FIG. 4 is a schematic flowchart of a motor starting method according to the present disclosure;

FIG. 5 illustrates angular addition increments at various sampling points in motor starting periods according to the motor starting method in the present disclosure;

FIG. 6 shows data curves of open-loop angular increments and a quadrature-axis reference current in a motor starting period according to the motor starting method of the present disclosure;

FIG. 7 shows the data curve of angle multiplied by the number of coil revolutions sampled at various points in a motor starting method according to the present disclosure;

FIG. 8 shows waveforms of an electrical angle according to the motor starting method of the present disclosure;

FIG. 9 shows the principle data curve of open-loop angular increments sampled at several time points which generate angular velocity fulfillment interrupt signal according to the motor starting method of the present disclosure;

FIG. 10 is a schematic structural block diagram of a motor starting circuit according to the present disclosure;

FIG. 11 is a schematic structural diagram of an angular acceleration control module according to the present disclosure;

FIG. 12 is a schematic structural block diagram of an addition unit according to the present disclosure;

FIG. 13 is another schematic structural diagram of an addition unit according to the present disclosure; and

FIG. 14 is a schematic principle diagram of multiplexing of an adder according to the present disclosure.

Reference numerals:

| | |
|---|---|
| 10 | Sampling module |
| 11 | First coordinate transformation module |
| 12 | Processor |
| 13 | Reference current auto-increment |
| | module |
| 14 | Angular acceleration control module |
| 141 | Addition unit |
| 1411, 1413a, 1413b, | Register |
| 1413c, . . . , 1413n | |
| 1412, 1415 | Adder |
| 1414 | Multi-path multiplexer |
| 142 | Sine and cosine function calculation |
| | unit |
| 143 | Upper limit control unit |
| 15 | Proportional integraladjustment module |
| 16 | Second coordinate transformation |
| | module |
| 17 | Control signal generation module |
| 18 | Driving module |
| 19 | Motor |

### DETAILED DESCRIPTION

The embodiments of the present disclosure will be described below. Those skilled can easily understand disclosure advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

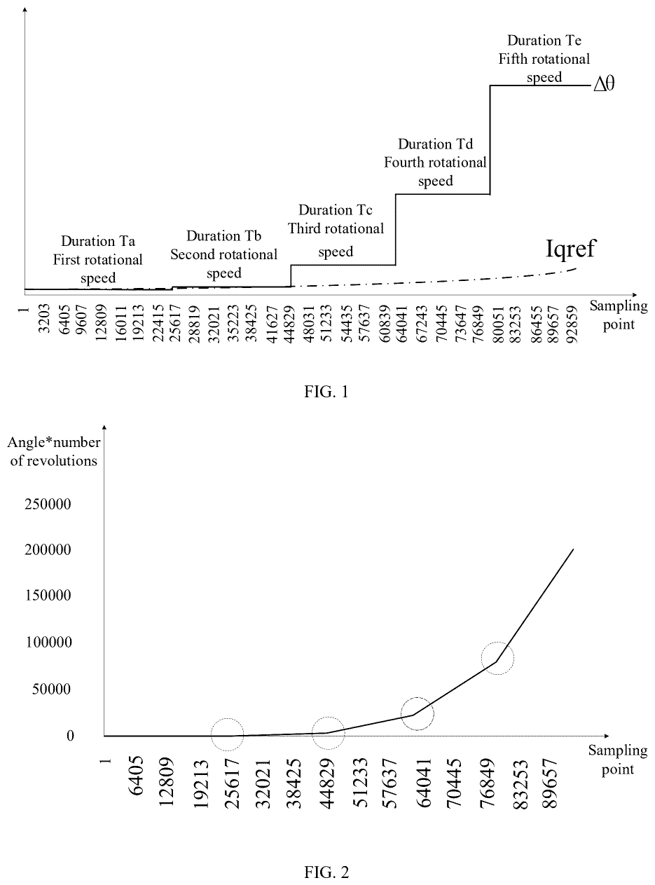

Refer to FIG. 1 to FIG. 14. It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

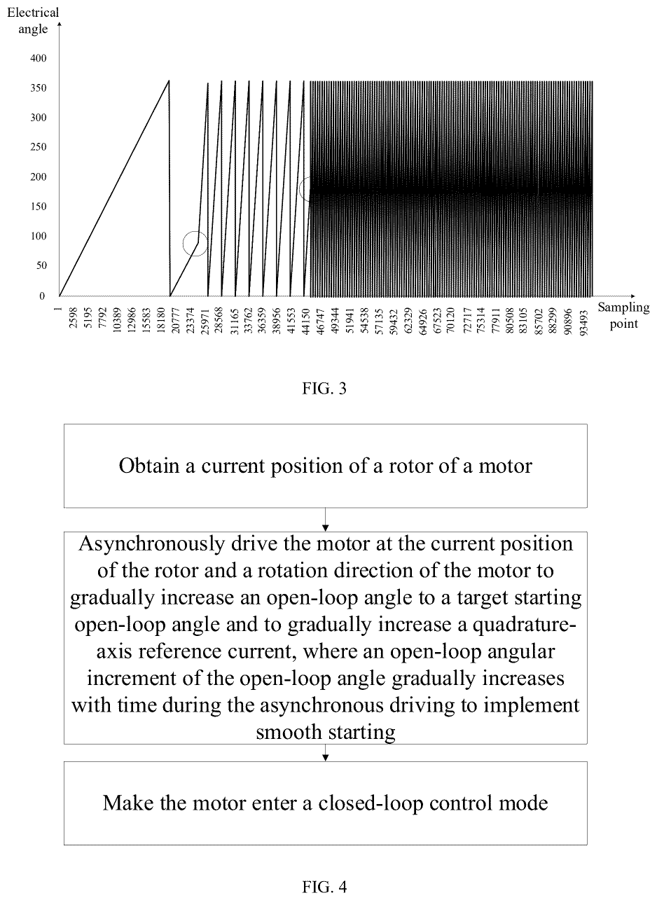

As shown in FIG. 1 to FIG. 3, in an embodiment of this specification, to shorten a motor starting time and increase a motor starting speed, an acceleration process of a motor is divided into a plurality of stages in an asynchronous driving stage, to achieve stable acceleration and avoid out-of-step of the motor during asynchronous driving. As an example, a PWM driving frequency of the motor is 20 Khz, a rated current of the motor is 2 A, and an open-loop starting target speed of the motor is 20,000 revolution/minute. Assuming that an initial positioning angle of the motor is exactly 0°, for stable starting of the motor, an accelerated asynchronous driving stage is divided into five acceleration stages. As shown in FIG. 1, a horizontal coordinate is sampling point (a quantity of peaks or valleys of a corresponding PWM signal). In the five acceleration stages, rotational speeds of the stages satisfy: a first rotational speed<a second rotational speed<a third rotational speed<a fourth rotational speed<a fifth rotational speed (i.e., a target rotational speed). Duration of the stages satisfy: first duration Ta<second duration Tb<third duration Tc<fourth duration Td<fifth duration Te. An open-loop angular increment Δθ remains unchanged in a same stage, and the open-loop angular increment Δθ gradually increases with time in the stages. As time elapses, a quadrature-axis reference current I_{qref} increments in an arithmetic progression in different stages. Asynchronous driving is performed on the motor according to proportional integrals of the asynchronous driving angle and the quadrature-axis reference current of the motor participating in FOC in the foregoing different stages, Clark/Park, and inverse transformation thereof. As shown in FIG. 2, turning points exist on a curve of a product of multiplying an angle θ and the number of revolutions in the stages. As shown in FIG. 3, an electrical angle of accelerated asynchronous driving in the stages have turning points at switching points of the stages.

As shown in FIG. 1, in the foregoing process, when the motor jumps from the first rotational speed into the second rotational speed, jumps from the second rotational speed into the third rotational speed, jumps from the third rotational speed into the fourth rotational speed, and jumps from the fourth rotational speed into the fifth rotational speed (a target rotational speed), the rotational speed of the motor jumps in steps, making an acceleration curve of the motor not smooth enough. During rotation, the motor has a clear “gear shifting” feeling, and in severe cases, the motor may fail to be started.

In addition, in the foregoing process, an angle and a reference current of asynchronous driving are usually adjusted by using a CPU. The CPU needs to detect in a PWM period of each motor whether a voltage and an open-loop angle reach stage thresholds, occupying a large number of CPU resources. This manner of controlling a starting circuit by a CPU shows more disadvantages especially in a scenario of expanding from a single-channel motor into a multi-channel motor.

For this, to optimize the foregoing embodiment, another embodiment of the present disclosure provides a motor starting method and a motor starting circuit, which uses smooth starting to overcome the “gear shifting” feeling during rotation of a motor and accelerates starting progress through an angular addition increment, and can also release CPU resources. Specific implementation solutions of the motor starting method and the motor starting circuit in this embodiment are as follows.

### Embodiment 1

As shown in FIG. 4, this embodiment provides a motor starting method. The motor starting method includes the following steps.
(1) Obtain a current position of a rotor.

Specifically, in a starting state, a motor is in a stationary state, and a position of the rotor is unknown. In this case, the motor is energized, and three-phase currents of the motor are acquired. In this way, the current position of the rotor is obtained. As an example, a direct-axis reference current Id of a to-be-controlled motor is controlled as a positioning target current, a quadrature-axis reference current Iq is controlled to be zero and is maintained for a period of time within a preset positioning stabilization time, to implement positioning of the rotor.

It needs to be noted that any method that can obtain the current position of the rotor is applicable to the present disclosure, and is not limited to this embodiment.
(2) Asynchronously drive a motor based on the current position of the rotor and a rotation direction of the motor to make an open-loop angle gradually increase to a target starting open-loop angle and a quadrature-axis reference current gradually increase, where an open-loop angular increment gradually increases with time during the asynchronous driving to implement smooth starting.

Specifically, the open-loop angle, the open-loop angular increment, and an angular addition increment (the angular addition increment is used for describing a speed at which the open-loop angular increment changes, i.e., an acceleration by which the open-loop angle changes) are introduced into the present disclosure, and the open-loop angle satisfies:

$${θ}_{n} = {θ}_{n - 1} + Δ {θ}_{n} , Δ {θ}_{n} = Δ {θ}_{n - 1} + {Δ}^{2} θ ,$$

where θₙ is the open-loop angle in a current period, θₙ₋₁ is the open-loop angle in a previous period, Δθₙ is the open-loop angle increment in the current period, Δθₙ₋₁ is the open-loop angular increment in the previous period, and Δ²θ is an angular addition increment. In other words, the open-loop angular increment increases with time. The angular addition increment Δ²θ is greater than zero, and a value of the angular addition increment Δ²θ may be set as required during actual use. The angular addition increment Δ²θ in a same stage is a constant value, and during actual use, the angular addition increment Δ²θ may gradually increase, decrease, or change irregularly with time, provided that the foregoing formula can be satisfied.

Specifically, the quadrature-axis reference current of the motor in the present disclosure satisfies:

$${I}_{qref ( n )} = {I}_{qref ( n - 1 )} + Δ {I}_{qref} ,$$

where I_{qref(n)} is the quadrature-axis reference current of the motor in the current period; I_{qref(n-1)} is the quadrature-axis reference current of the motor in the previous period; and ΔI_{qref} is a quadrature-axis reference current increment, and a specific value may be set as required. Details are not described herein again.

More specifically, in this embodiment, the open-loop angle is adjusted in stages, the angular addition increment Δ²θ of the open-loop angle in periods in a same stage is a constant value, and the angular addition increment Δ²θ of the open-loop angle in stages gradually increases with time. In this way, while smooth starting is implemented, starting progress can be accelerated. Further, in this embodiment, the angular addition increment corresponding to the stages are calculated based on a driving frequency of the motor, a target rotational speed in the stages, and a target angular increment in the stages. It is assumed that the driving frequency of the motor is constantly f hertz, i.e., f PWM waveforms of the motor appear within one second. A stage target of an i^{th} stage is to increase a rotational speed to N revolution/second within Tᵢ seconds. It is known that an initial value of a stage initial open-loop angular increment is Δθᵢ₀, and the number of pole-pairs of the motor is p, where i≥1, and i is a natural number. When i=1, a one-stage acceleration process occurs. The one-stage acceleration process does not affect the smoothness of motor starting, and the one-stage acceleration process can better shorten a motor starting time. The open-loop angular increment in the last PWM period within Tᵢ seconds may be calculated by using the foregoing conditions, and is referred to as a stage target angular increment Δθᵢ₀. When the open-loop angular increment of the running of the motor reaches Δθᵢ₀ at the discrete point, in this case, the rotational speed of the motor at the point is N revolution/second. The stage target angular increment Δθᵢ₀ satisfies the following formula:

$$Δ {θ}_{i n} = \frac{N \times 360 ° \times p}{{T}_{i} \times f} .$$

Because the open-loop angular increment Δθ manifests an arithmetic progression property in the stages, it may be obtained that a stage angular addition increment Δ²θᵢ in the ith stage satisfies:

$${Δ}^{2} {θ}_{i} = \frac{Δ {θ}_{in} - Δ {θ}_{i 0}}{{T}_{i} \times f - 1} .$$

When i≥2, the stage initial open-loop angular increment in the ith stage is equal to the stage target angular increment in an (i−1)^{th} stage, i.e., Δθᵢ₀=Δθ₍ᵢ₋₁₎ₙ. When i=1, the stage initial open-loop angular increment in a first stage may be set as required. Details are not described herein again.

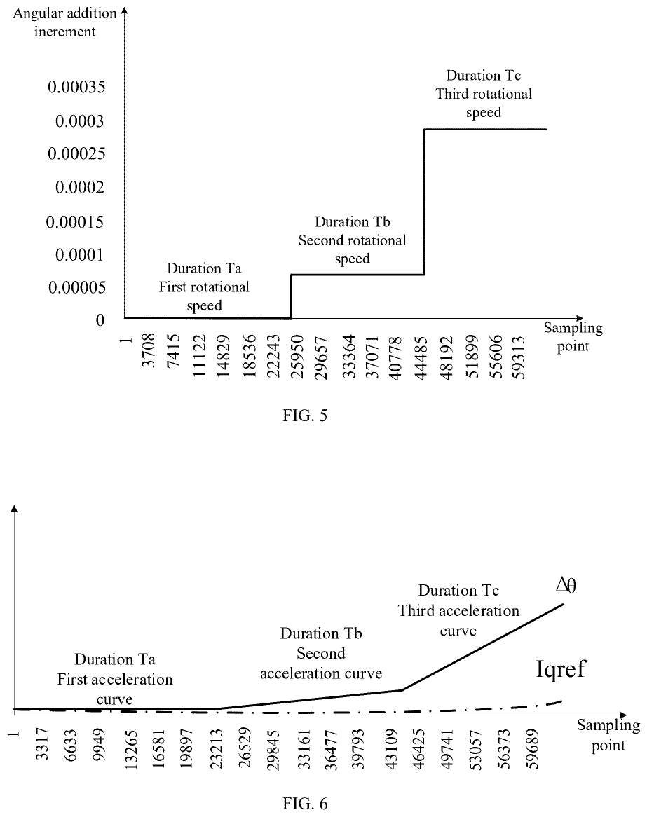

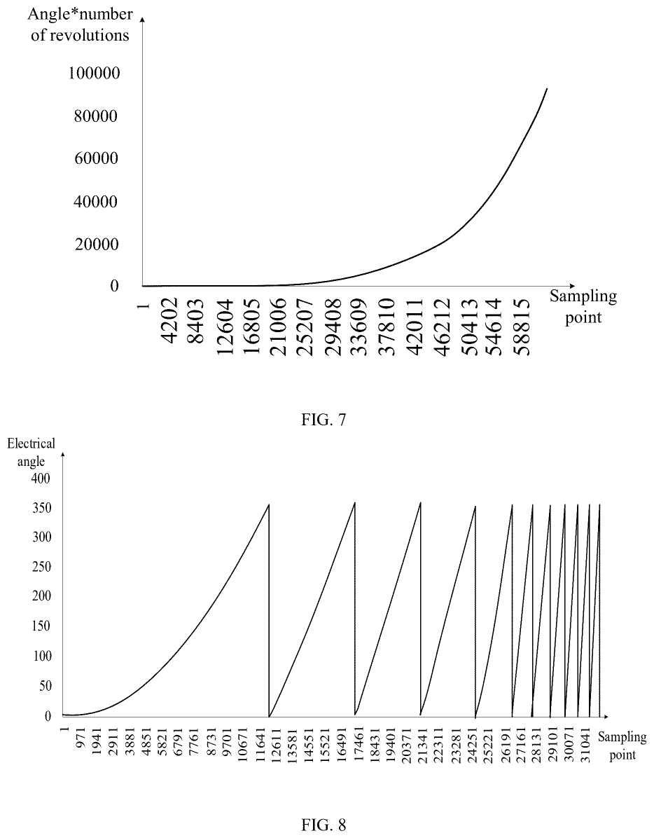

As shown in FIG. 5 to FIG. 7, as an example, the open-loop angle is adjusted in three stages. It is assumed that the driving frequency of the motor is 20 K hertz, the rated current of the motor is 2 amperes, and an open-loop starting target speed of the motor is 20,000 revolution/minute. An initial asynchronous driving angle of the motor is an initial positioning angle (0° in the following example). As shown in FIG. 5, the angular addition increment in a same stage is a constant value, the angular addition increment in the first stage, the angular addition increment in a second stage, and the angular addition increment in a third stage in a step form. As shown in FIG. 6, the open-loop angular increment in a same stage increases in an arithmetic progression. The accelerations in the stages satisfy: a first acceleration<a second acceleration<a third acceleration. The quadrature-axis reference current I_{qref} increments in an arithmetic progression. Duration in the stages satisfies: first duration Ta<second duration Tb<third duration Tc. Asynchronous driving is performed on the motor according to proportional integrals of the asynchronous driving angle and the quadrature-axis reference current of the motor participating in FOC in the foregoing different stages, Clark/Park, and inverse transformation thereof. As shown in FIG. 7, a curve of a product of multiplying an angle θ and the number of revolutions in the stages is smooth, and has no turning point. As shown in FIG. 8, an electrical angle of accelerated asynchronous driving in the stages has no turning point at switching points of the stages. It needs to be noted that during actual use, a quantity of stages of stage control may be set as required, and is not limited to this embodiment.

Specifically, as an implementation of the present disclosure, when the open-loop angular increment in each stage reaches the target angular increment in the corresponding stage, an angular velocity fulfillment interrupt signal is triggered, and the angular addition increment and the quadrature-axis reference current increment are cleared; and the angular addition increment and the quadrature-axis reference current increment in a next stage are recalculated, or the open-loop angular increment and the quadrature-axis reference current in the current period are maintained. In this embodiment, as shown in FIG. 9, 0 to a moment T1 is the first stage. When the open-loop angular increment in the first stage reaches the target angular increment in the first stage, a first angular velocity fulfillment interrupt signal is triggered at the moment T1. The moment T1 to a moment T2 is the second stage. When the open-loop angular increment in the second stage reaches the target angular increment in the second stage, a second angular velocity fulfillment interrupt signal is triggered at the moment T2. The moment T2 to a moment T3 is the third stage. When the open-loop angular increment in the third stage reaches the target angular increment (which is also the target angular increment throughout asynchronous driving) in the third stage, a third angular velocity fulfillment interrupt signal is triggered at the moment T3. When the open-loop angular increment reaches the value of the stage target angular increment, an angular acceleration controller sends an angular velocity fulfillment interrupt signal, and clears the angular addition increment (Δ²θ=0) and the quadrature-axis reference current increment (ΔI_{qref}=0). It may be known according to the angular velocity fulfillment interrupt signal that a stage smooth acceleration is completed, and according to a specific status of the running of the motor, a new angular addition increment Δ²θ and a new quadrature-axis reference current increment ΔI_{qref} are configured, to cause the motor to enter a next stage smooth acceleration. Alternatively, a new angular addition increment is no longer configured, i.e., Δ²θ=0, and a new quadrature-axis reference current increment is no longer configured, i.e., ΔI_{qref}=0, to enable the motor to enter a stable running link, to enter closed-loop control of the motor.

It needs to be noted that in this example, it is determined by detecting the open-loop angular increment whether the open-loop angle reaches a preset open-loop angle. The open-loop angle may be directly detected during actual use. Any manner that can determine the moments T1, T2, and T3 is applicable. Details are not described herein again.
(3) Make the motor enter a closed-loop control mode.

Specifically, in this embodiment, after the motor is accelerated to the target rotational speed, a back electromotive force is calculated in an observer manner, and an estimation angle is obtained by calculating arc tangents of direct-axis and quadrature-axis back electromotive forces. When a difference between an open-loop running angle and the estimation angle is within a particular range, it may be determined that closed-loop conditions are met, and the motor enters a closed-loop mode.

It needs to be noted that any method that can make the motor enter closed-loop control is applicable to the present disclosure, and is not limited to this embodiment. It needs to be noted that for the starting of a plurality of motors, the motors may be started one by one based on the motor starting method in this embodiment. Details are not described herein again.

The concept Δ²θ of the angular addition increment is introduced into the present disclosure, to make a change curve of the asynchronous driving angle of the motor become smoother. The “gear shifting” feeling in motor rotation is reduced through smooth starting, starting progress is accelerated, and a motor starting time is shortened, thereby improving efficiency and also reducing a probability of reducing starting inversion.

### Embodiment 2

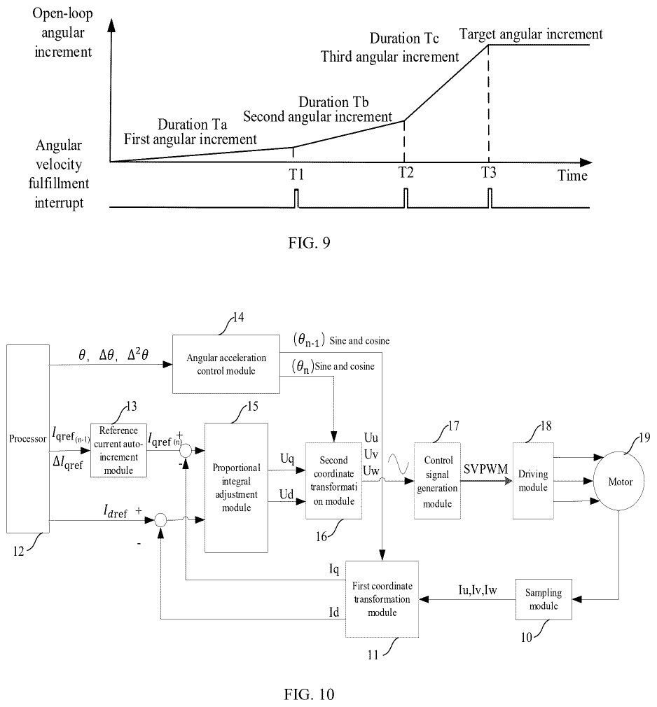

As shown in FIG. 10, this embodiment provides a motor starting circuit. The motor starting circuit includes:
a sampling module 10, a first coordinate transformation module 11, a processor 12, a reference current auto-increment module 13, an angular acceleration control module 14, a proportional integral adjustment module 15, a second coordinate transformation module 16, a control signal generation module 17, a driving module 18, and a motor 19.

As shown in FIG. 10, the sampling module 10 samples a current of the motor 19.

Specifically, the sampling module 10 includes a sampling circuit, connected to the motor 19. Three-phase currents (Iu, Iv, and Iw) of the motor 19 are sampled. During actual use, only two-phase currents may be used, and the third phase is calculated.

As shown in FIG. 10, the first coordinate transformation module 11 is connected to an output end of the sampling module 10 and an output end of the angular acceleration control module 14, and performs coordinate transformation on an output signal of the sampling module 10 to obtain a direct-axis current Id and a quadrature-axis current Iq.

Specifically, in this embodiment, the first coordinate transformation module 11 performs Clark transformation and/or Park transformation. Three-phase currents outputted by the sampling module 10 participate in Clark/Park transformation of FOC based on an (n−1)^{th} asynchronous driving angle θₙ₋₁ to obtain the direct-axis current Id and the quadrature-axis current Iq.

As shown in FIG. 10, the processor 12 provides a direct-axis reference current I_{dref}, a quadrature-axis reference current I_{qref}, a quadrature-axis reference current increment ΔI_{qref} in stages, an initial angle θ, an initial open-loop angular increment Δθ, and an angular addition increment Δ²θ in the stages.

Specifically, in this embodiment, the processor 12 is implemented by using a central processing unit (CPU). During actual use, any module that can implement data processing is applicable to the present disclosure, and includes, but not limited to, a micro-processing unit (MPU), an application-specific integrated circuit (ASIC), a digital signal processor (DSP), a graphics processing unit (GPU), an image signal processor (ISP), or a field-programmable gate array (FPGA). The angular addition increment Δ²θ in the stages is calculated based on the calculation method in Embodiment 1. Details are not described herein again.

As shown in FIG. 10, the reference current auto-increment module 13 is connected to an output end of the processor 12, and obtains the quadrature-axis reference current I_{qref(n)} in a current period based on the quadrature-axis reference current I_{qref(n-1)} in a previous period and the quadrature-axis reference current increment ΔI_{qref}.

Specifically, the following relational expression is satisfied: I_{qref(n)}=I_{qref(n-1)}+ΔI_{qref}.

As shown in FIG. 10, the angular acceleration control module 14 is connected to the output end of the processor 2, and adjusts an open-loop angle to a target starting open-loop angle based on the initial angle θ, the initial open-loop angular increment Δθ, and the angular addition increment Δ²θ, where an open-loop angular increment gradually increases with time.

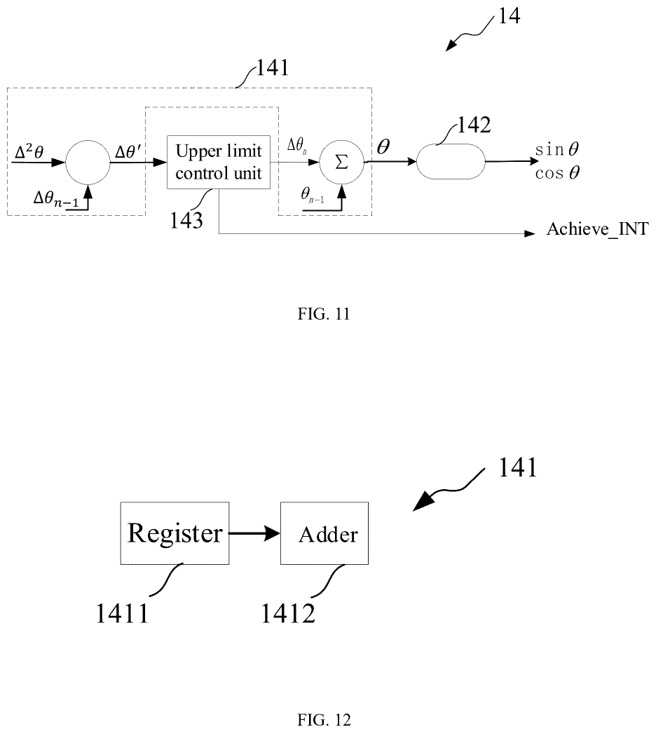

Specifically, as shown in FIG. 11, the angular acceleration control module 14 includes an addition unit 141 and a sine and cosine function calculation unit 142. The addition unit 141 obtains the open-loop angle θₙ₋₁ in the previous period, the open-loop angular increment Δθₙ₋₁ in the previous period, and the angular addition increment Δ²θ in the current period to perform an addition operation to obtain the open-loop angular increment Δθₙ in the current period and the open-loop angle θₙ in the current period. The addition unit 141 adds the open-loop angular increment Δθₙ₋₁ in the previous period and the angular addition increment Δ²θ in the current period to obtain the open-loop angular increment Δθₙ in the current period. The addition unit 141 further adds the open-loop angular increment Δθₙ in the current period and the open-loop angle θₙ₋₁ in the previous period to obtain the open-loop angle θₙ in the current period. The sine and cosine function calculation unit 142 is connected to an output end of the addition unit 141, and performs sine and cosine function calculation on the open-loop angle θₙ outputted by the addition unit 141, where a sine and a cosine function outputted by the sine and cosine function calculation unit 142 are configured for motor starting control. As another implementation of the present disclosure, to further obtain the release of processor resources, the angular acceleration control module 14 further includes an upper limit control unit 143. The upper limit control unit 143 is connected to the addition unit 141; when the open-loop angular increment Δθₙ in the current period reaches a stage target angular increment, sends an angular velocity fulfillment interrupt signal Achieve_INT, clears the angular addition increment (Δ²θ=0) and the quadrature-axis reference current increment (ΔI_{qref}=0), and notifies the processor 12 to update the angular addition increment Δ²θ and the quadrature-axis reference current increment ΔI_{qref} in a next stage or no longer configure a new angular addition increment (Δ²θ=0) and a new quadrature-axis reference current increment (ΔI_{qref}=0), to enable the motor to enter a stable running process to enter a closed-loop control stage of the motor; and when the open-loop angular increment Δθₙ in the current period is less than the target angular increment in the corresponding stage, controls the addition unit 141 to perform an addition operation based on the open-loop angle Δθₙ₋₁ in the previous period and the open-loop angular increment Δθₙ in the current period to obtain the open-loop angle θₙ in the current period. Δθ′ in FIG. 11 is an intermediate quantity of the open-loop angular increment, and Δθₙ obtained by the upper limit control unit 143 is the actual open-loop angular increment (an output value of a first-level adder is 0).

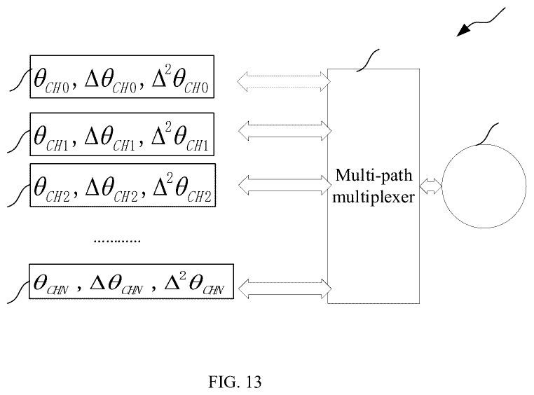

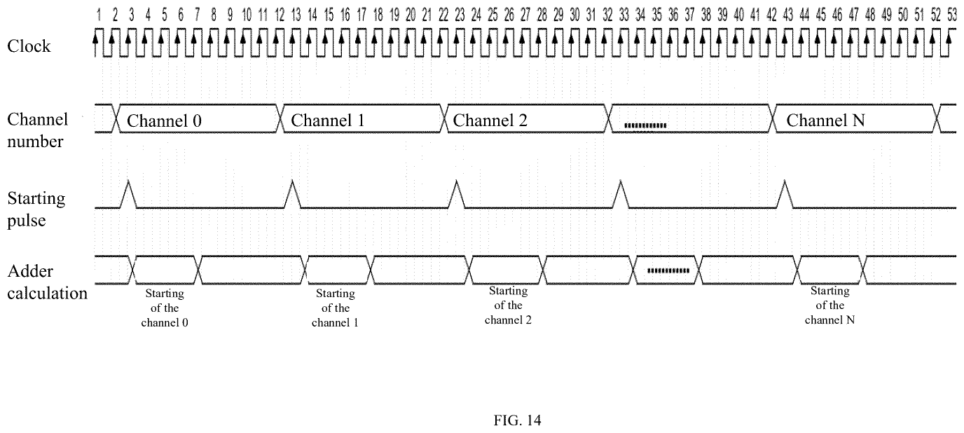

More specifically, in this embodiment, a same adder calculates the open-loop angular increment Δθₙ in the current period and the open-loop angle θₙ in the current period in the addition unit 141, which is implemented through time division multiplexing. During actual use, a plurality of adders may be arranged as required to respectively implement calculation of the open-loop angular increment Δθₙ in the current period and the open-loop angle θₙ in the current period. As an example, as shown in FIG. 12, for an application of starting a single motor, the addition unit 141 includes a register 1411 and an adder 1412. The open-loop angle, the open-loop angular increment, and the angular addition increment in the periods are stored in the register 1411. The adder 1412 is connected to the register 1411, and performs the addition operation on the open-loop angle θₙ₋₁ in the previous period, the open-loop angular increment Δθₙ₋₁ in the previous period, and the angular addition increment Δ²θ to obtain the open-loop angle θₙ in the current period. As another example, as shown in FIG. 13, for an application of starting a plurality of motors, the addition unit 141 includes at least two registers 1413 where each register corresponds to one motor (in this example, 1413a, 1413b, 1413c, . . . , and 1413n are arranged) and an adder 1415. Open-loop angles, open-loop angular increments, and angular addition increments of plurality of motors are respectively stored in the multiple registers, i.e., each register corresponds to one motor. The multi-path multiplexer 1414 is connected to output ends of the registers, and selects one of the registers and outputs data in the selected register. The multi-path multiplexer 1414 may be gated individually in a channel sequence according to a selection control signal, or may set a gating sequence as required according to a selection control signal. Details are not described herein again. The adder 1415 is connected to an output end of the multi-path multiplexer 1414, and performs the addition operation on the open-loop angle in the previous period, the open-loop angular increment in the previous period, and the angular addition increment at the output end of the multi-path multiplexer 1414 to obtain the open-loop angle in the current period of the corresponding motor. The adder 1415 is multiplexed by a plurality of motors, so that costs can be effectively reduced. As shown in FIG. 14, under the action of a clock, a motor corresponding to a channel 0 is first processed, a starting pulse is effective, and the adder performs an addition operation on data of the channel 0; after the processing is completed, a motor corresponding to a channel 1 is processed, similarly, the starting pulse is effective, and the adder performs an addition operation on data of the channel 1; and the rest is deduced by analogy, to complete the calculation of the open-loop angles of the motors one by one.

It needs to be noted that for the operating principle of the angular acceleration control module 14, refer to Embodiment 1. Details are not described herein again.

As shown in FIG. 10, the proportional integral adjustment module 15 is connected to the first coordinate transformation module 11, the processor 12, and an output end of the reference current auto-increment module 13, and performs an proportional integral adjustment operation based on the direct-axis current I_{d}, the direct-axis reference current I_{dref}, the quadrature-axis current I_{q}, and the quadrature-axis reference current I_{qref} to obtain a direct-axis voltage U_{d} and a quadrature-axis voltage U_{q}.

Specifically, the proportional integral adjustment module 15 includes an integrator circuit. During actual application, any structure that can implement a proportional integral operation is applicable to the proportional integral adjustment module 15 in the present disclosure. Details are not described herein again. The direct-axis current I_{d} and the direct-axis reference current I_{dref} are used to participate in a proportional integral adjustment operation of FOC to obtain the direct-axis voltage U_{d}. The quadrature-axis current I_{q} and the quadrature-axis reference current I_{qref} are used to participate in a proportional integral adjustment operation of FOC to obtain the quadrature-axis voltage U_{q}.

The control signal generation module generates a control signal for the motor based on an output signal of the second coordinate transformation module.

The driving module is connected to an output end of the control signal generation module, and generates a driving signal for the motor based on the control signal and drives the motor to start.

As shown in FIG. 10, the second coordinate transformation module 16 is connected to the angular acceleration control module 14 and an output end of the proportional integral adjustment module 15, and performs coordinate transformation on the direct-axis voltage U_{d} and the quadrature-axis voltage U_{q} to obtain three-phase voltages.

Specifically, in this embodiment, the second coordinate transformation module 16 performs Clark inverse transformation and/or Park inverse transformation. The direct-axis voltage U_{d} and the quadrature-axis voltage U_{q} participate in Clark/Park inverse transformation of FOC through sine and cosine function values of an nth asynchronous driving angle θₙ to obtain three-phase voltages (Uu, Uv, Uw).

As shown in FIG. 10, the control signal generation module 17 generates a control signal for the motor 19 based on an output signal of the second coordinate transformation module 16.

Specifically, in this embodiment, the control signal generation module 17 generates an SVPWM signal.

As shown in FIG. 10, the driving module 18 is connected to an output end of the control signal generation module 17, and generates a driving signal for the motor 19 based on the control signal and drives the motor 19 to start.

Specifically, in this embodiment, the driving module 18 includes a driving board (for example, a motor driver circuit board), transforming a low-voltage domain signal into a high-voltage domain signal to drive the motor 19 to run. During actual use, any circuit structure that can drive the motor to run based on the control signal of the motor is applicable to the present disclosure, and is not limited to this embodiment.

It needs to be noted that for an application scenario of starting a plurality of motors, a quantity of the driving modules 18 needs to be kept consistent with a quantity of the motors 19.

As shown in FIG. 10, the motor 19 is connected to an output end of the driving module 18, and is driven by the driving module 18 to operate.

Specifically, in this embodiment, the motor 19 is a permanent magnet synchronous motor without a position sensor. During actual use, any motor without a position sensor or motor with a position sensor is applicable, and is not limited to this embodiment.

In the present disclosure, starting information (including, but not limited to, the open-loop angle, the open-loop angular increment, and the angular addition increment) of a plurality of channels is kept in the angular acceleration control module, and the processor may access a same register group to implement parameter access and motor starting of a motor of any channel. A time division multiplexing manner is used to only select information of one channel at a same moment to start the motor, and after the calculation ends, information of a next channel is then selected to start a next motor. A calculation process of a plurality of channels does not require participation of a processor, and the processor is notified to adjust the angular addition increment Δ²θ and the quadrature-axis reference current increment only when calculation is completed, thereby greatly reducing the burden of the processor, and easy expansion into any channel can be implemented.

It is easier to implement the present disclosure in hardware by setting the angle θ, the open-loop angular increment Δθ, and the angular addition increment Δ²θ, and it is only necessary to repeatedly use an adder and a limiter to complete a starting process, so that a small number of hardware resources are reduced, and the release of CPU resources is implemented, thereby reducing the time of planning an acceleration curve by a software engineer to enable the motor to start more successfully and smoothly. The smooth starting is used, so that the “gear shifting” feeling in motor rotation is reduced during rate switching. In addition, because the concept of the angular addition increment is introduced, starting progress is accelerated, a motor starting time is shortened, a success rate of motor starting is improved, and a probability of starting inversion is reduced within a particular range.

In summary, the present disclosure provides a motor starting method and a motor starting circuit. The method includes: (1) obtaining a current position of a rotor; (2) asynchronously driving the motor at the current position of the rotor and the rotation direction of the motor, to gradually increase the open-loop angle to a target starting open-loop angle and to gradually increase the quadrature-axis reference current, where the open-loop angular increment gradually increases with time during the asynchronous driving, thus to implement smooth starting; and (3) entering the motor into a closed-loop control mode. Introducing the open-loop angle, the open-loop angular increment, and the angular addition increment into the motor starting method and the motor starting circuit enables easier implementing the starting circuit in hardware, such that a starting process can be completed by repeatedly using just one adder, thus consuming only a few hardware resources, freeing up CPU resources. Smooth starting is implemented by adjusting the open-loop angular increment, so the “gear shifting” feeling in motor rotation is reduced during rate switching. The introduction of the angular addition increment greatly accelerates starting progress and suppresses a probability of starting inversion within a particular range. The present disclosure can be expanded to any group of motors, and a same group of computational logic is multiplexed for starting of the motors, so that costs are reduced. Therefore, the present disclosure effectively overcomes various shortcomings in the existing technology and has high industrial utilization value.

The above-mentioned embodiments are merely illustrative of the principle and effects of the present disclosure instead of restricting the scope of the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. A motor starting method of a motor, wherein the motor starting method at least comprises:
(1) obtaining a current position of a rotor of the motor;
(2) asynchronously driving the motor at the current position of the rotor and a rotation direction of the motor to gradually increase an open-loop angle to a target starting open-loop angle and to gradually increase a quadrature-axis reference current, wherein an open-loop angular increment of the open-loop angle increase gradually increases with time during the asynchronous driving to implement smooth starting; and
(3) making the motor enter a closed-loop control mode.

2. The motor starting method according to claim 1, wherein the open-loop angle satisfies:
$${θ}_{n} = {θ}_{n - 1} + Δ {θ}_{n} ,$$
$$and$$
$${Δθ}_{n} = Δ {θ}_{n - 1} + {Δ}^{2} θ ,$$
wherein θₙ is the open-loop angle in a current period, θₙ₋₁ is the open-loop angle in a previous period, Δθₙ is the open-loop angle increment in the current period, Δθₙ₋₁ is the open-loop angular increment in the previous period, and Δ²θ is an open-loop angular addition increment.

3. The motor starting method according to claim 2, wherein the open-loop angle is adjusted in stages in Step (2), the angular addition increment of the open-loop angle in periods in a same stage is a constant value, and the angular addition increment of the open-loop angle in stages gradually increases with time.

4. The motor starting method according to claim 2, wherein the angular addition increment of the open-loop angle in an i^{th} stage in Step (2) satisfies:
$${Δ}^{2} {θ}_{i} = \frac{Δ {θ}_{\dot{m}} - Δ {θ}_{i 0}}{{T}_{i} \times f - 1} ,$$
$$and$$
$${Δθ}_{i n} = \frac{N \times 360 ° \times p}{{T}_{i} \times f} ,$$
wherein Δ²θᵢ is the angular addition increment of the open-loop angle in the i^{th} stage, and i is a natural number greater than or equal to 1; Δθᵢₙ is a target angular increment in the last period in the i^{th} stage; Δθᵢ₀ is the open-loop angular increment in a first period in the i^{th} stage; Tᵢ is a time length in seconds of the i^{th} stage; f is a driving frequency of the motor; N is a target rotational speed in the i^{th} stage; p is a number of pole-pairs of the motor; and when the natural number i≥2, Δθᵢ₀=Δθ₍ᵢ₋₁₎ₙ, and Δθ₍ᵢ₋₁₎ₙ is the target angular increment in a last period in an (i−1)^{th} stage.

5. The motor starting method according to claim 4, wherein when the open-loop angular increment in each stage reaches the target angular increment in a corresponding stage, an angular velocity fulfillment interrupt signal is triggered, and the angular addition increment and a quadrature-axis reference current increment are cleared; and the angular addition increment and the quadrature-axis reference current increment in a next stage are either recalculated, or the open-loop angular increment and the quadrature-axis reference current in the current period are maintained.

6. A motor starting circuit of a motor, wherein the motor starting circuit at least comprises:
a sampling module, a first coordinate transformation module, a processor, a reference current auto-increment module, an angular acceleration control module, a proportional integral adjustment module, a second coordinate transformation module, a control signal generation module, a driving module, and a motor;
wherein the sampling module samples an electric current of the motor;
wherein the first coordinate transformation module is connected to an output end of the sampling module and an output end of the angular acceleration control module, and performs coordinate transformation on an output signal of the sampling module to obtain a direct-axis current and a quadrature-axis current;
wherein the processor provides a direct-axis reference current, a quadrature-axis reference current, a quadrature-axis reference current increment, an initial angle, an initial open-loop angular increment, and an angular addition increment;
wherein the reference current auto-increment module is connected to an output end of the processor, and obtains the quadrature-axis reference current in a current period based on the quadrature-axis reference current in a previous period and the quadrature-axis reference current increment;
wherein the angular acceleration control module is connected to the output end of the processor, and adjusts an open-loop angle to a target starting open-loop angle based on the initial angle, the initial open-loop angular increment, and the angular addition increment, wherein an open-loop angular increment gradually increases with time;
wherein the proportional integral adjustment module is connected to an output end of the first coordinate transformation module, the output end of the processor, and an output end of the reference current auto-increment module, and performs a proportional integral adjustment operation to obtain a direct-axis voltage and a quadrature-axis voltage based on the direct-axis current, the direct-axis reference current, the quadrature-axis current, and the quadrature-axis reference current;
wherein the second coordinate transformation module is connected to the angular acceleration control module and an output end of the proportional integral adjustment module, and performs coordinate transformation on the direct-axis voltage and the quadrature-axis voltage to obtain three-phase voltages;
wherein the control signal generation module generates a control signal for the motor based on an output signal of the second coordinate transformation module; and
wherein the driving module is connected to an output end of the control signal generation module, generates a driving signal for the motor based on the control signal and drives the motor to start.

7. The motor starting circuit according to claim 6, wherein the angular acceleration control module comprises an addition unit and a sine and cosine function calculation unit;
wherein the addition unit obtains the open-loop angle in the previous period, the open-loop angular increment in the previous period, and the angular addition increment in the current period to perform an addition operation to obtain the open-loop angular increment in the current period and the open-loop angle in the current period; and
wherein the sine and cosine function calculation unit is connected to an output end of the addition unit, and performs sine and cosine function calculation on the open-loop angle in the current period outputted by the addition unit, wherein a sine and a cosine function outputted by the sine and cosine function calculation unit are configured for motor starting control.

8. The motor starting circuit according to claim 7, wherein the angular acceleration control module further comprises an upper limit control unit connecting to the addition unit;
wherein when the open-loop angular increment reaches a stage target angular increment, the upper limit control unit sends an angular velocity fulfillment interrupt signal, and when the open-loop angular increment is less than the stage target angular increment in the corresponding stage, the upper limit control unit controls the addition unit to perform an addition operation based on the open-loop angle in the previous period and the open-loop angular increment in the current period to obtain the open-loop angle in the current period.

9. The motor starting circuit according to claim 7, wherein the addition unit comprises a register and an adder;
wherein the open-loop angle, the open-loop angular increment, and the angular addition increment are stored in the register; and
wherein the adder is connected to the register, and performs the addition operation on the open-loop angle in the previous period, the open-loop angular increment in the previous period, and the angular addition increment to obtain the open-loop angular increment in the current period and the open-loop angle in the current period.

10. The motor starting circuit according to claim 7, wherein the addition unit comprises a multi-path multiplexer, an adder, and at least two registers;
wherein open-loop angles, open-loop angular increments, and angular addition increments of motors are stored in the at least two registers;
wherein the multi-path multiplexer is connected to output ends of the at least two registers, and selects one of the at least two registers and outputs data in the selected register; and
wherein the adder is connected to an output end of the multi-path multiplexer, and performs the addition operation on the open-loop angle in the previous period, the open-loop angular increment in the previous period, and the angular addition increment at the output end of the multi-path multiplexer to obtain the open-loop angular increment in the current period and the open-loop angle in the current period.

11. The motor starting circuit according to claim 6, wherein the driving module comprises a driving board, transforming a low-voltage domain signal into a high-voltage domain signal to drive the motor to run.

12. The motor starting circuit according to claim 6, wherein the motor is a permanent magnet synchronous motor without a position sensor.

13. The motor starting circuit according to claim 10, wherein the multi-path multiplexer chooses individually in an order according to a selection control signal, or chooses in an order based on needs according to the selection control signal.

14. The motor starting circuit according to claim 10, wherein the adder is multiplexed with a plurality of motors, wherein each path of the at least two registers corresponds to one of the plurality of motors, and wherein under the action of a clock, the adder follows steps of:
at first processing one of the plurality of motors corresponding to one path of the at least two registers, if a starting pulse is effective, performing the addition operation on data of the corresponding path of the at least two registers;
then processing another of the plurality of motors corresponding to a next path of the at least two registers, if the starting pulse is effective, performing the addition operation on data of the next path of the at least two registers; and
one by one, completing calculation of open-loop angles of the plurality of motors.

15. The motor starting circuit according to claim 6, wherein the second coordinate transformation module implements Clark inverse transformation and/or Park inverse transformation, and the direct-axis voltage and the quadrature-axis voltage participate in Clark inverse transformation and/or Park inverse transformation of field-oriented control (FOC) to obtain the three-phase voltages.
